(19) United States
(12) Patent Application Publication
(10) Pub. No.: US 2003/0154179 A1
(43) Pub. Date: Aug. 14, 2003

(54) Virtual scratch card system and method

(76) Inventor: David E.W. Mercer, Bothell, WA (US)

Correspondence Address: Olympic Patent Works, PLLC, P.O. Box 4277, Seattle, WA, 98104, US

(21) Appl. No.: 10/072,632

(22) Filed: Feb. 8, 2002

(51) Int. Cl. G06F 7/00

(52) U.S. Cl. 707/1

(57) ABSTRACT

The present application provides for a virtual scratch card-like system in a wireless network environment. The virtual scratch card system allows for receipt of token-based payments, the redemption of those payments, and for the exchange of token-based payments for smaller denominations of token-based payments.

### FIELD OF THE INVENTION

The present invention relates to electronic commerce, and more specifically, to a method and system for providing virtual “scratch card” payments over a wireless communications network.

### BACKGROUND OF THE INVENTION

Scratch cards are well-known promotion and gaming items in which a consumer scratches off a layer of material to reveal some type of prize or message on the scratch card. The scratch cards have been used for both promotions and gaming rewards and other forms of amusement, as well as security devices. However, conventional scratch cards require some form of physical distribution. Accordingly, there is a need and desire for a similar mechanism to distribute rewards, promotions, gaming and the like.

In wireless networking environments, it has been conventional to send voice and digital data across wireless networks. However, it has been difficult to send secure payments and/or promotions via such wireless networks. Accordingly, there is a need for some type of promotion or payment mechanism that may be securely transmitted across wireless networks as forms of promotion, gaming, and the like.

In particular, there is a need and desire for combining the promotion and amusement features of scratch cards with a secure payment mechanism and wireless communications.

### SUMMARY OF THE INVENTION

To fulfill the unmet technological needs of previous systems, the present invention provides a method and system of issuing virtual scratch cards in a wireless network. In one aspect of the present invention, the virtual tokens are retrieved from a token database and sent to a consumer device in a wireless network to issue a virtual scratch card to a consumer. The token database is then updated to mark that virtual token as issued so that it will not be issued again.

The virtual scratch cards may then be redeemed over the wireless network or via a conventional telephone network. When initiating the redemption process, a redemption request is authenticated using a consumer device, such as a cellular phone. The authentication includes validating a virtual scratch card included in the redemption request. Once the virtual scratch card is validated, the consumer receives a credit to an account associated with their consumer device. Again, the token database is updated to reflect that the virtual scratch card has been used and, therefore, cannot be used again.

In another aspect of the present invention, the virtual scratch cards may be exchanged for “change cards” that are of a smaller denomination. The change process includes authenticating a change request from a consumer device, including validating an original virtual scratch card included in the change request. Next, a number of virtual scratch cards of smaller denomination than the first virtual scratch card are retrieved and sent to the consumer device. In addition, the original virtual scratch card is marked invalid so that it may not be used again and the change tokens are marked as issued in the VSC database.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of a number of telecommunication devices connected to a mobile communications device for issuing and redeeming virtual scratch cards in accordance with the present invention;

FIG. 2 is a pictorial diagram of a number of devices connected to a mobile communications device for issuing, redeeming, and making change for virtual scratch cards in accordance with the present invention;

FIG. 3 is a block diagram illustrating several components of the interactive voice response server shown in FIGS. 1 and 2 used to communicate and authenticate a consumer in accordance with the present invention;

FIG. 4 is a block diagram illustrating several of the components of a third party server shown in FIGS. 1 and 2 used to issue virtual scratch cards in accordance with the present invention;

FIG. 5 is a block diagram illustrating several of the components of a prepaid billing system server shown in FIGS. 1 and 2 used to process the redemption of virtual scratch cards in accordance with the present invention;

FIG. 6 is a block diagram illustrating several of the components of a change-making device shown in FIG. 2 used to make change for virtual scratch cards in accordance with the present invention;

FIG. 7 is a diagram illustrating the actions taken by a third party server, short message service center, mobile switching center, and mobile communications device when issuing a virtual scratch card to a consumer in accordance with the present invention;

FIG. 8 is a diagram illustrating the actions taken by a mobile communications device, interactive voice response server, prepaid billing system server, and virtual scratch card database when redeeming a virtual scratch card in accordance with the present invention;

FIG. 9 is a diagram illustrating the actions taken by a mobile communications device, mobile switching center, short message service center, virtual scratch card proxy, prepaid billing system, and virtual scratch card database when redeeming a virtual scratch card using a wireless messaging system in accordance with the present invention;

FIG. 10 is a diagram illustrating the actions taken by a mobile communications device, mobile switching center, short message service center, virtual scratch card change-making device, and third party database, and virtual scratch card database when requesting change for a virtual scratch card in accordance with the present invention;

FIG. 11 is an overview flow diagram illustrating a process of issuing a virtual scratch card from a third party server in accordance with the present invention;

FIG. 12 is an overview flow diagram illustrating a process for redeeming a virtual scratch card utilizing interactive voice technology in accordance with the present invention;

FIG. 13 is an overview flow diagram illustrating a virtual scratch card redemption process performed via the prepaid billing system in accordance with the present invention;

FIG. 14 is an overview flow diagram illustrating a virtual scratch card change-making process performed by a change-making device in accordance with the present invention; and

FIGS. 15 and 16 illustrate exemplary screen shots showing the receipt verification and value verification of a virtual scratch card respectively, in accordance with the present invention.

### DETAILED DESCRIPTION OF THE PREFERRED EMBODIMENT

The present invention is directed to providing a virtual payment or scratch card method and system that will allow consumers of devices within a wireless network to receive virtual scratch cards. These virtual scratch cards may be embodied in text messages sent to consumers. More specifically, the invention provides for issuing these virtual scratch cards to consumer devices over a wireless network. In accordance with other aspects of the present invention, the virtual payment system and method provides for the redemption of these virtual scratch cards and for the issuance of change to a virtual scratch card. This enables the consumer to both receive and use the virtual scratch cards in an efficient and effective manner. Additionally, the issuer of the scratch cards is able to do away with physical distribution points and the cost and hassle of providing physical scratch cards to the consumer. A better understanding of how this is accomplished will be found in the detailed description below.

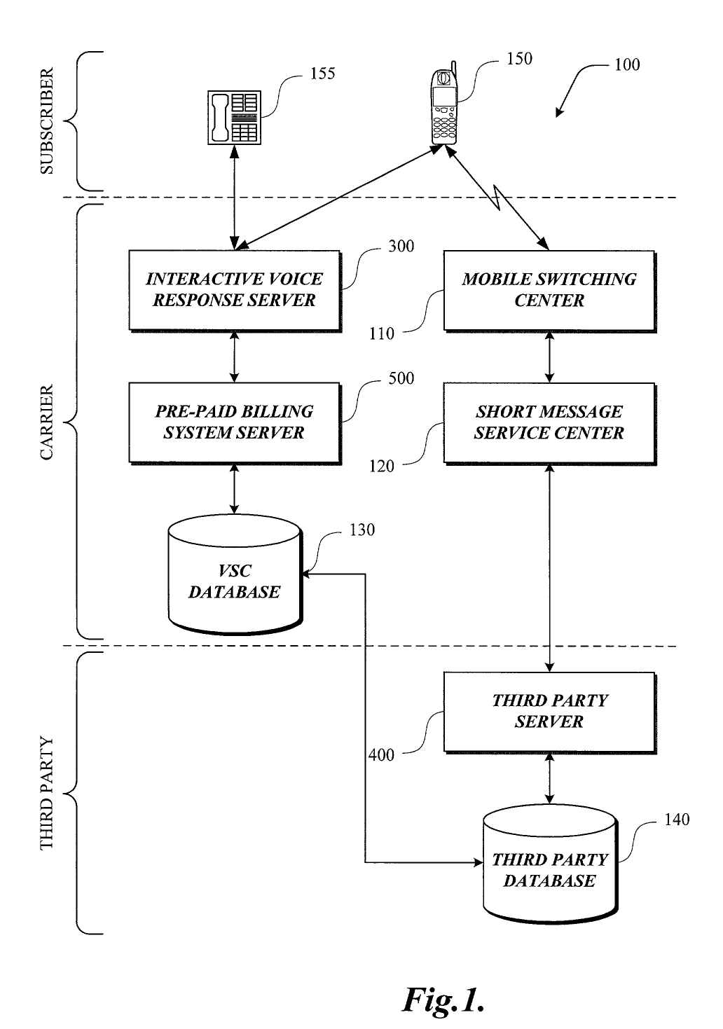

A virtual payment system 100 utilizing interactive voice technology formed in accordance with the present invention is shown in FIG. 1. More specifically, the system 100 comprises an interactive voice response server 300, a third party server 400, and a prepaid billing system server 500. In addition to the interactive voice response server 300, third party server 400 and a prepaid billing system server 500, the system 100 includes at least one mobile switching center 110, short message service center 120, virtual scratch card (VSC) database 130, third party database 140, mobile communications device 150 and optionally a landline telephone 155. Moreover, those of ordinary skill in the art will recognize that while only one interactive voice response server 300, third party server 400, prepaid billing system server 500, mobile switching center 110, short message service center 120, VSC database 130, third party database 140, mobile communications device 150 and optional landline telephone 155 are depicted in FIG. 1, numerous interactive voice response servers 300, third party servers 400, prepaid billing system servers 500, mobile switching centers 110, short message service centers 120, VSC databases 130, third party databases 140, mobile communications devices 150 and optional landline telephones 155 may be interconnected to operate in accordance with the present invention.

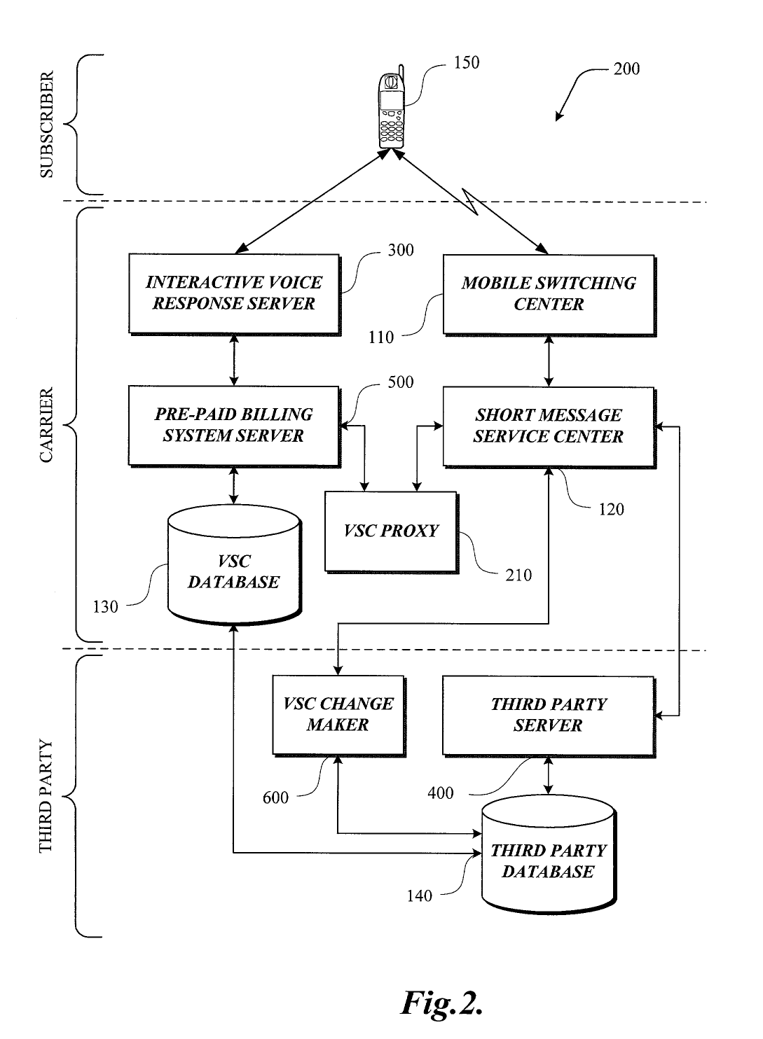

Another embodiment of the virtual payment system, which provides for wireless messaging, is shown in FIG. 2. The system 200 comprises an interactive voice response server 300, third party server 400, and a prepaid billing system server 500. In addition, the system 200 includes at least one mobile switching center 110, short message service center 120, VSC database 130, third party database 140, mobile communications device 150, a VSC proxy 210 and a VSC change maker 600. Moreover, those of ordinary skill in the art will recognize that while only one interactive voice response server 300, third party server 400, prepaid billing system server500, mobile switching center 110, short message service center 120, VSC database 130, third party database 140, mobile communications device 150, VSC proxy 210 and a VSC change maker 600 are depicted in FIG. 2, numerous interactive voice response servers 300, third party servers 400, prepaid billing system servers 500, mobile switching centers 110, short message service centers 120, VSC databases 130, third party databases 140, mobile communications devices 150, VSC proxies 210 and a VSC change makers 600 may be interconnected to operate in accordance with the present invention.

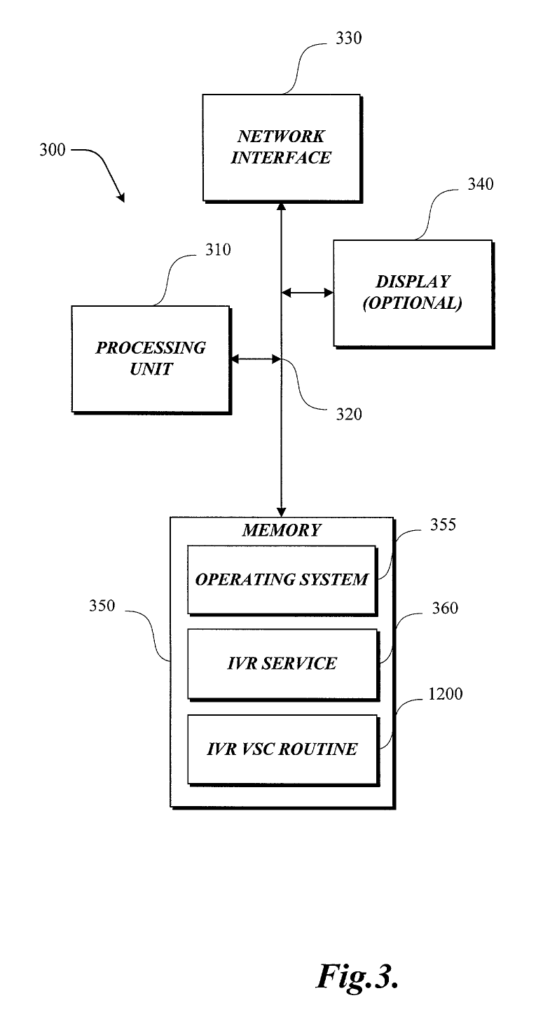

FIG. 3 depicts several of the key components of an interactive voice response server 300 used to authenticate and interact with consumers using voice signals in accordance with the present invention. Those of ordinary skill in the art will appreciate that the interactive voice response server 300 includes many more components than those shown in FIG. 3. However, it is not necessary that all of these generally conventional components be shown in order to disclose an illustrative embodiment for practicing the present invention. As shown in FIG. 3, the interactive voice response server 300 includes a network interface 330 for connecting to a digital and/or telephony network (not shown). As will be appreciated by those of ordinary skill in the art, the network interface 330 includes the necessary circuitry for such connection, and is constructed for use with appropriate protocols (e.g., networking protocols and/or telephony protocols), the particular network configuration of the network it is connecting to, and a particular type of coupling medium. Alternatively the interactive voice response server 300 may also be equipped with additional network interfaces for connecting to other networks as known to those skilled in the art.

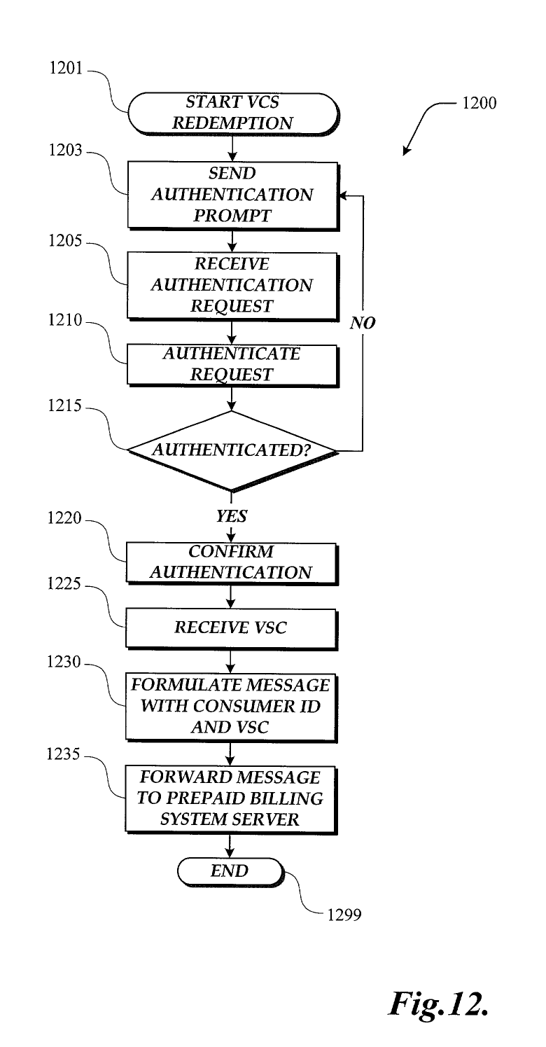

The interactive voice response server 300 also includes a central processing unit 310, optionally a display 340, and a memory 350 connected via a bus 320. The memory 350 generally comprises random access memory (“RAM”), and read-only memory (“ROM”) and a persistent mass storage device such as but not limited to a hard disk drive, tape drive, optical drive (such as a CD ROM or DVD ROM), floppy disk drive, or combination thereof. The memory 350 stores an operating system 355 for controlling the operation of the interactive voice response server 300. The memory also includes an interactive voice response service 360 which includes voice recognition and voice synthesis capabilities as is known to those of ordinary skill in the art. Additionally the memory contains an interactive voice response virtual scratch card redemption routine 1200 for recognizing and processing virtual scratch card information in accordance with the present invention, and as further described below with regard to FIG. 12. It will be appreciated that these components may be stored on a computer readable medium and loaded into memory 350 of the interactive voice response server 300 using a drive mechanism associated with the computer-readable medium, such as a floppy or a CD ROM/DVD ROM drive, or the network interface 330.

Although in one embodiment the interactive voice response server is a general purpose computing device, those of ordinary skill in the art will appreciate that the interactive voice response server 300 could be any of a number of specially configured devices capable of communicating with and interpreting responses from a consumer in accordance with the present invention.

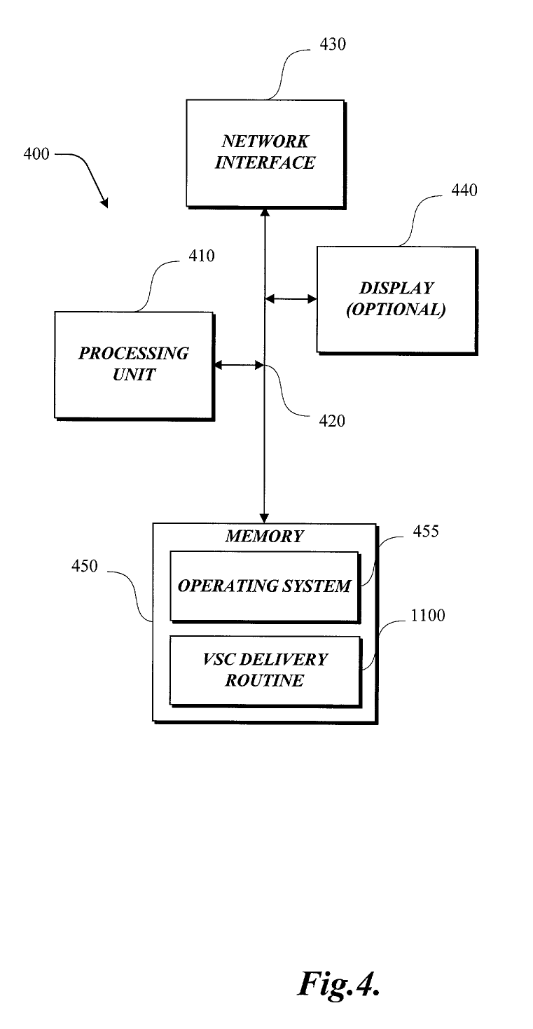

FIG. 4 depicts several of the components of a third party server 400 used to implement the present invention. Those of ordinary skill in the art will appreciate that the third party server 400 includes many more components than those shown in FIG. 4. However, it is not necessary that all of these generally conventional components be shown in order to disclose an illustrative embodiment for practicing the present invention. As shown in FIG. 4, the third party server 400 is connected to a network and other devices in the system 100 or system 200 via a network interface 430. Those of ordinary skill in the art will appreciate the network interface 430 includes the necessary circuitry for connecting the third party server 400 to the other devices of the system 100 and the system 200, and is constructed for use with the appropriate network protocols.

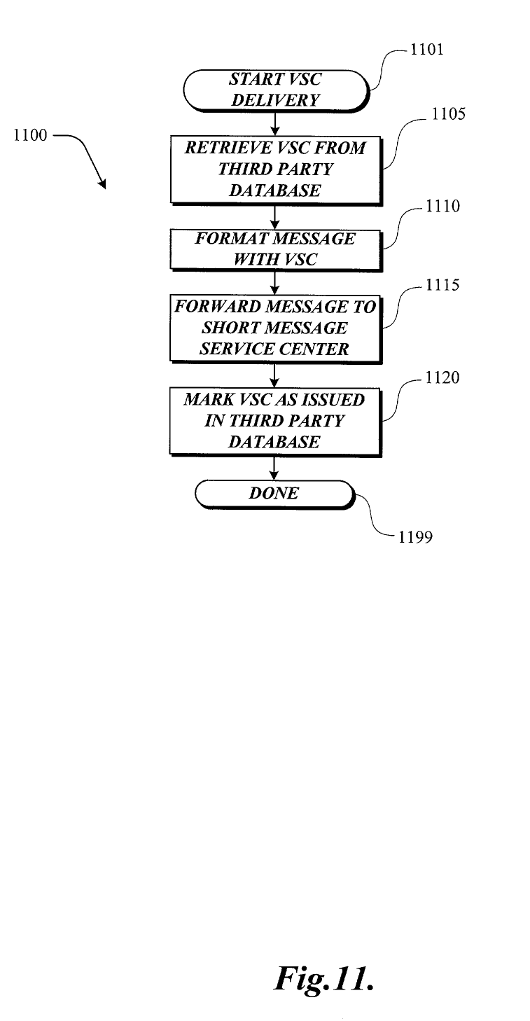

The third party server 400 also includes a central processing unit 410, optionally a display 440 and a memory 450 connected via a bus 420. The memory 450 generally comprises RAM, ROM, and some form of persistent mass storage device such as a hard disk drive, tape drive, optical drive (such as a CD ROM or DVD ROM), floppy disk drive, or combination thereof. The memory 450 stores an operating system 455 for controlling the operation of the third party server 400. Additionally the memory 400 stores a virtual scratch card issuing routine 1100 for issuing virtual scratch cards to consumers in accordance with the present invention. The virtual scratch card issuing routine 1100 is described in greater detail below with reference to FIG. 11. It will be appreciated that these components may be stored on a computer readable medium and loaded into memory 450 of the third party server 400 using a drive mechanism associated with the computer-readable medium, such as a floppy or a CD ROM/DVD ROM drive, or the network interface 430.

Although in one embodiment the third party server 400 is a general computing device, those of ordinary skill in the art will appreciate that the third party server 400 could be any type of customized device capable of issuing virtual scratch cards to a consumer in accordance with the present invention.

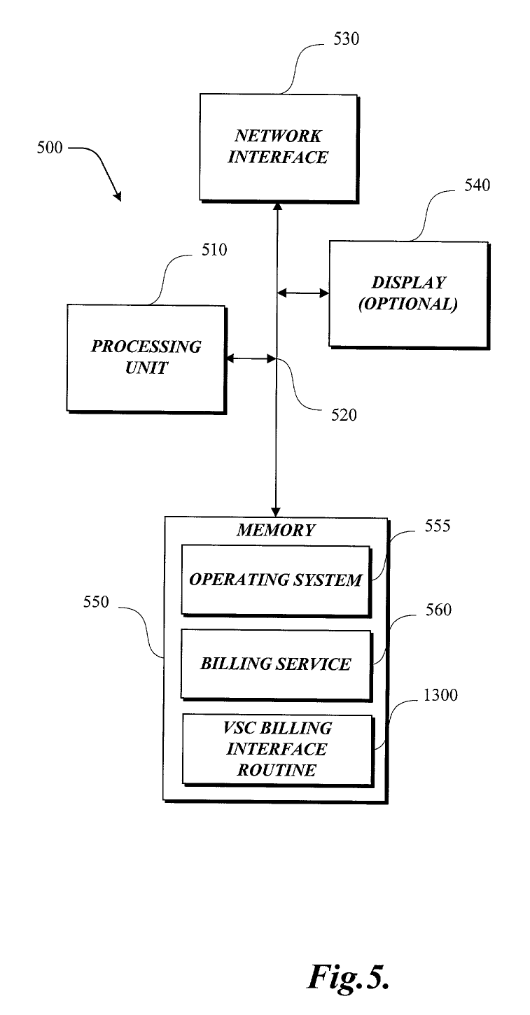

FIG. 5 depicts several of the key components of a prepaid billing system server 500 used to implement the present invention. Those of ordinary skill in the art will appreciate that the prepaid billing system server 500 includes many more components than those shown in FIG. 5. However, it is not necessary that all of the generally conventional components be shown in order to disclose an illustrative embodiment for practicing the present invention. As shown in FIG. 5, the prepaid billing system server 500 includes a network interface 530 for connecting to a network and/or other devices in system 100 or system 200. It will be appreciated by those of ordinary skill in the art the network interface 530 includes the necessary circuitry for such a connection, and is constructed for use with the appropriate network protocols, the particular network configuration it is connecting to, and a particular type of coupling medium as known to those skilled in the art.

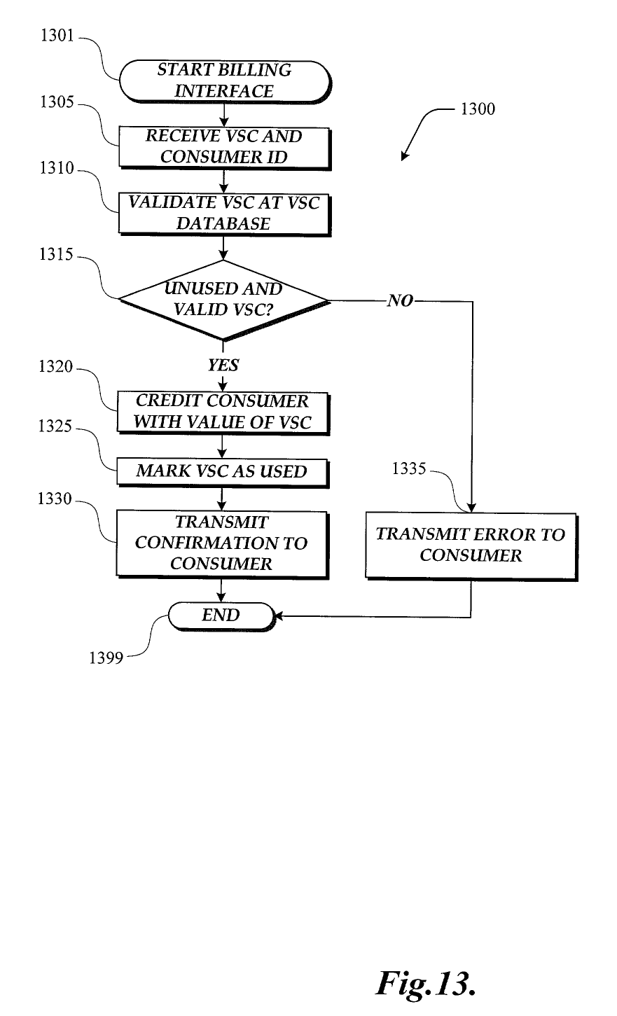

The prepaid billing service server 500 also includes a central processing unit 510, optionally a display 540, and a memory 550 connected via a bus 520. The memory 550 generally comprises RAM, ROM and some form of persistent mass storage device such as a hard disk drive, tape drive, optical drive, floppy disk drive, or combination thereof. The memory 550 stores an operating system 555 for controlling the operations of the prepaid billing system server 500. The memory 550 also includes a billing service for managing the crediting, debiting and oversight of consumer accounts as known to those of ordinary skill in the art. Additionally the memory 550 includes a virtual scratch card billing interface routine 1300 for crediting or debiting a consumer's account in accordance with the present invention. The virtual scratch card billing interface routine 1300 is described in greater detail below with reference to FIG. 13. It will be appreciated that these components may be stored on a computer readable medium and loaded into memory 550 of the prepaid billing system server 500 using a drive mechanism associated with the computer-readable medium, such as a floppy or a CD ROM/DVD ROM drive, or the network interface 430. Although in one embodiment the prepaid billing service server 500 is represented as a general purpose computing device, those of ordinary skill in the art will appreciate that the prepaid billing service server 500 may be any form of general or specialized computing device capable of handling prepaid billing operations in accordance with the present invention.

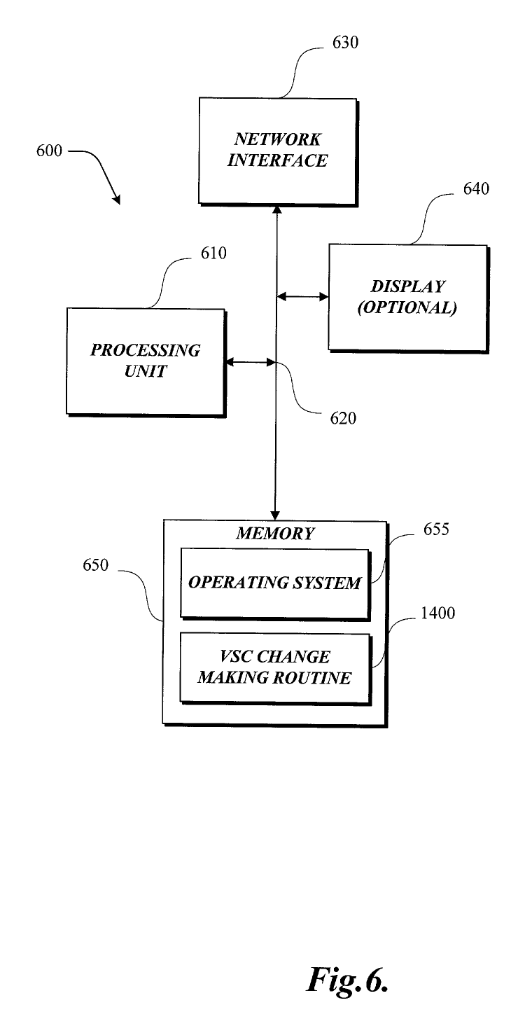

FIG. 6 depicts several of the key components of a virtual scratch card change-making device 600 used to make change for virtual scratch cards in accordance with the present invention. Those of ordinary skill in the art will appreciate that the virtual scratch card change-making device 600 includes many more components than those shown in FIG. 6. However, it is not necessary that all of these generally conventional components be shown in order to disclose an illustrative embodiment for practicing the present invention. As shown in FIG. 6, the virtual scratch card change-making device 600 includes a network interface unit 630 for connecting to a network (not shown). As will be appreciated by those of ordinary skill in the art, the network interface unit 630 includes the necessary circuitry for such a connection, and is constructed for use with the appropriate network protocols, the particular network configuration of the network it is connecting to, and a particular type of coupling medium.

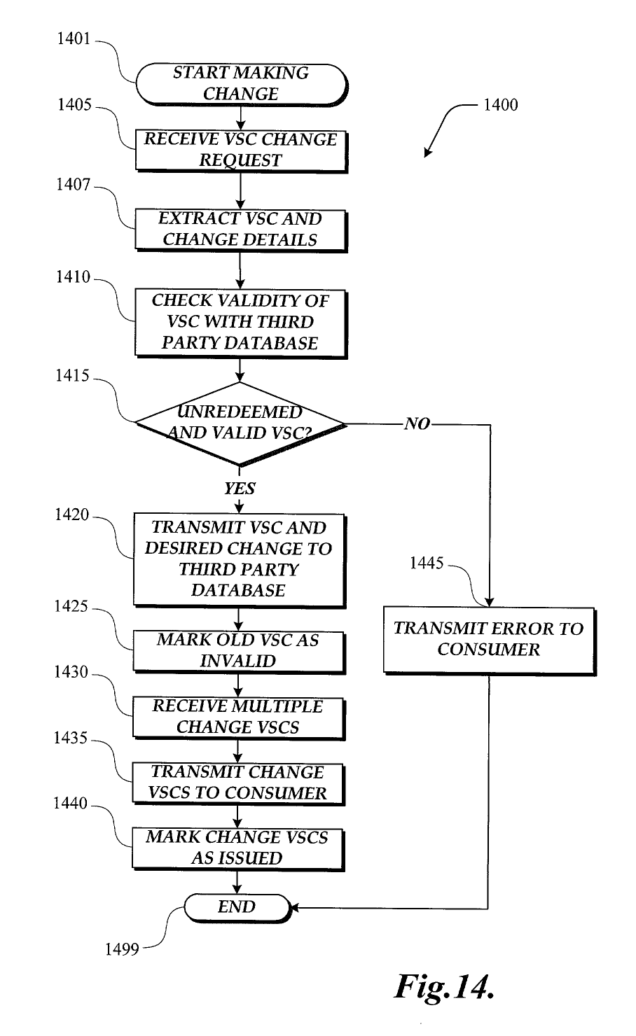

The virtual scratch card change-making device 600 also includes a central processing unit 610, optionally a display 640, and a memory 650 connected via a bus 620. The memory 650 generally comprises RAM, ROM and a persistent mass storage device such as a hard disk drive, tape drive, optical drive, floppy disk drive, or a combination thereof. The memory 650 stores an operating system 655 for controlling the operation of the virtual scratch card change-making device 600. The memory 650 also includes a virtual scratch card change-making routine 1400 for making change from virtual scratch cards in accordance with the present invention. The virtual scratch card change-making routine 1400 is described in greater detail below with regard to FIG. 14. It will be appreciated that these components may be stored in a computer-readable medium and loaded into memory 650 of the virtual scratch card change-making device 600 using a drive mechanism associated with the computer-readable medium, such as a floppy or CD ROM/DVD ROM drive, or the network interface 630.

While FIGS. 3-6 describe separate devices, those of ordinary skill in the art will appreciate that one or more of the devices illustrated in FIGS. 3-6 as well as the other devices and databases illustrated in FIGS. 1 and 2 may be combined into one or more devices and still operate in accordance with the present invention. For example, the interactive voice response server 300 and the prepaid billing system server 500 may be incorporated into a unitary device without otherwise affecting the operation of the present invention.

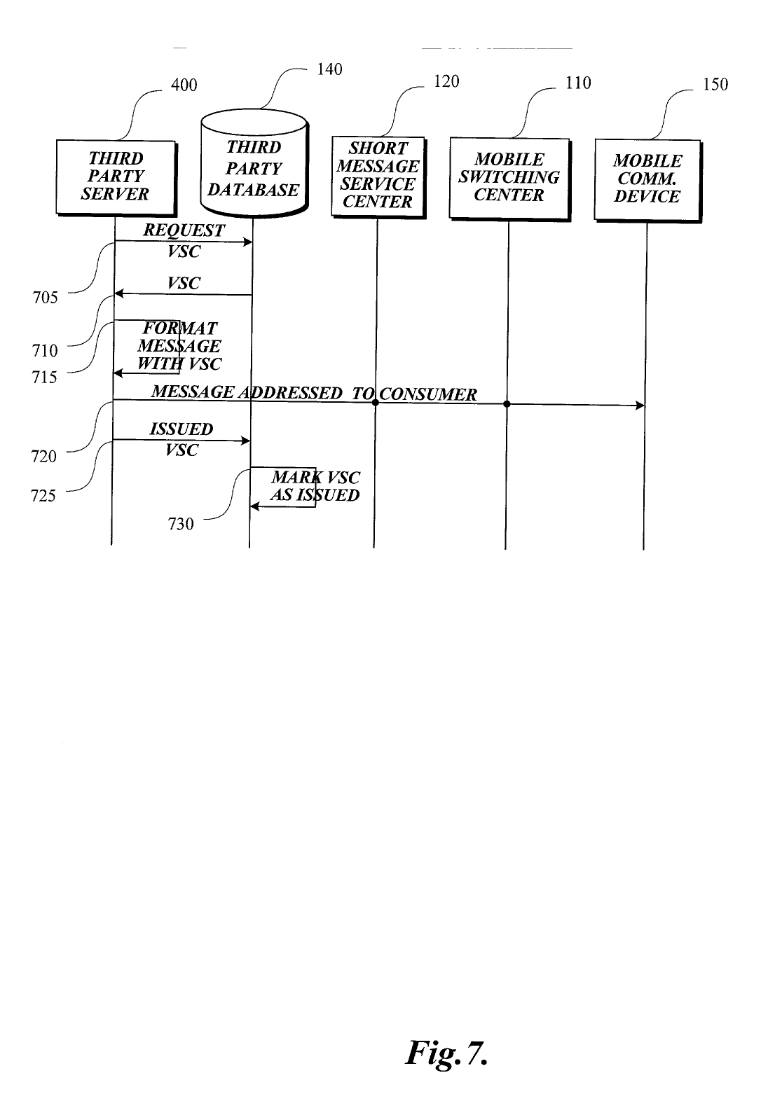

FIG. 7 illustrates the actions taken by the third party server 400, third party database 140, short message service center 120, mobile switching center 110, and the mobile communications device 150 to enable a message containing a virtual scratch card to be issued to a consumer in possession of the mobile communications device 150 in accordance with the present invention. The process of which is illustrated and described in greater detail in FIG. 12. Returning to FIG. 7, the virtual scratch card issuing process is initiated when a third party server 400 requests 705 a virtual scratch card from a third party database 140. The third party database 140 returns the virtual scratch card 710 to the third party server 400. Once the third party server 400 has a virtual scratch card it is then able to format 715 a message containing the virtual scratch card. Then the message is sent 720 to the mobile communications device 150 using a wireless messaging system, such as one containing a short message service center 120 and a mobile switching center 110 which route the message to the mobile communications device 150. Next the third party server marks the virtual scratch card as issued 725 by issuing it to the third party database 140. The third party database 140 then also marks the virtual scratch card as issued 730 so that the same virtual scratch card is never issued again.

Once a consumer has a virtual scratch card, they may use it, or alternately, trade it with other entities (consumers or merchants) in exchange for currency, goods, or services. In particular, this is facilitated by using e-mail or wireless messaging between mobile communication devices. By simply copying the text embodying the virtual scratch card, the consumer is able to transfer the value to another recipient.

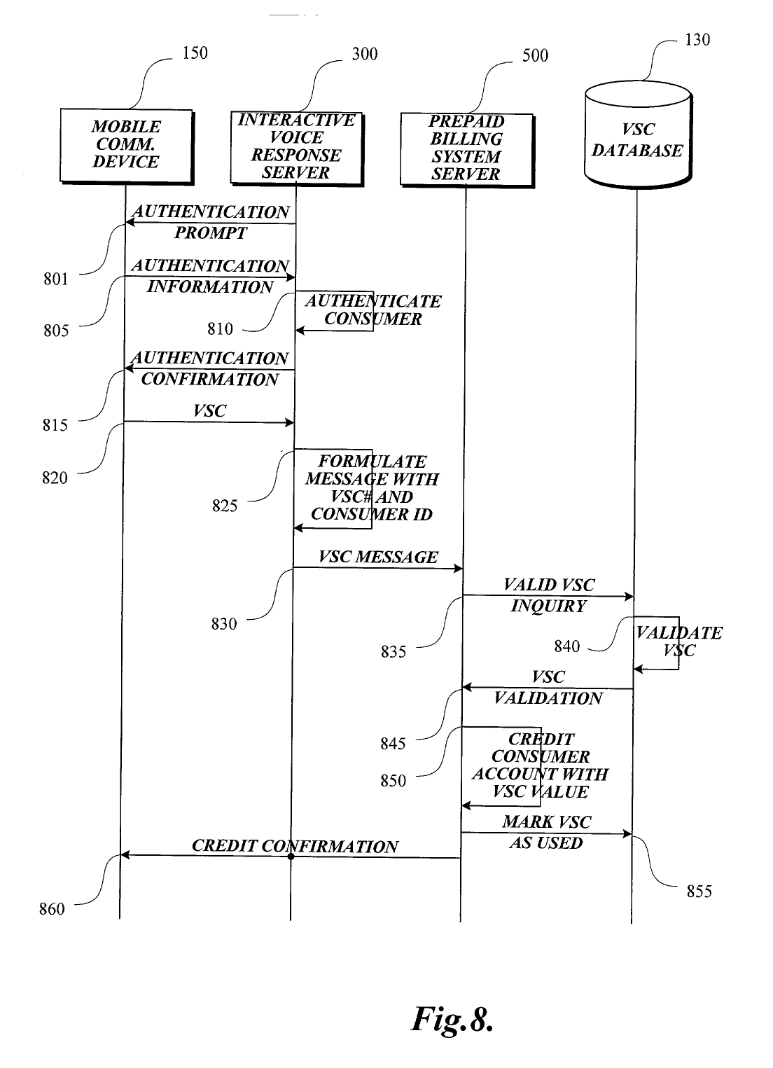

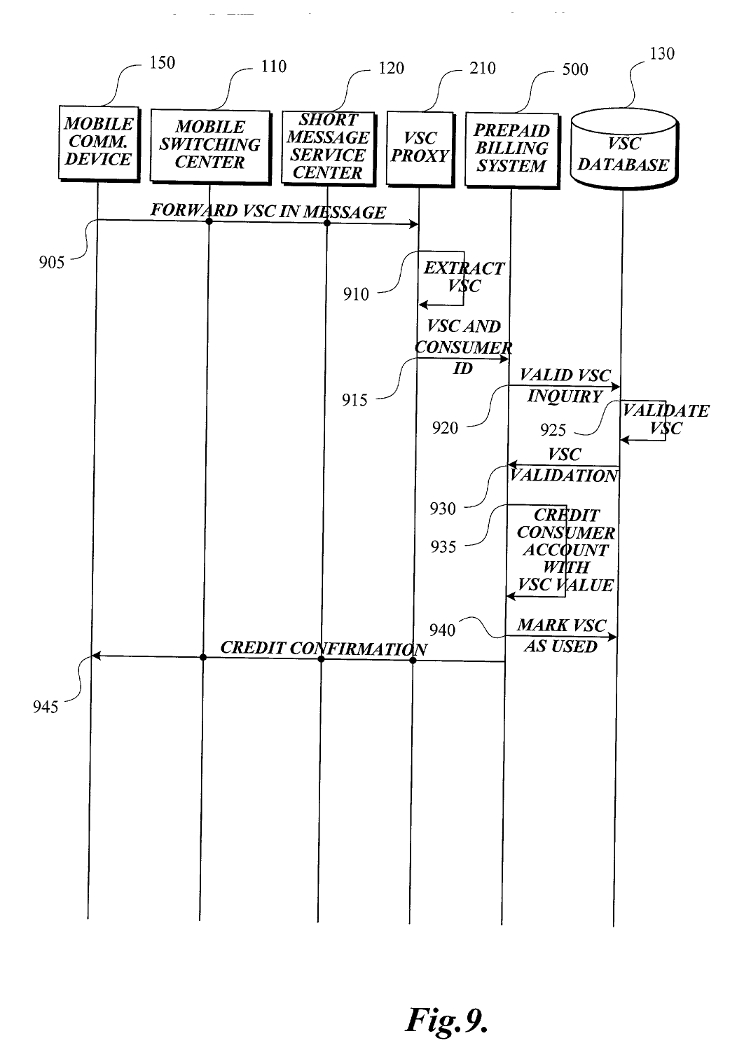

It will be appreciated by those of ordinary skill in the art that the order of operations in FIG. 7 may be altered without substantially affecting the operation of the present invention. For example, the third party server 400 may mark a virtual scratch card as issued prior to sending a message to the mobile communications device 150 without departing from the spirit and scope of the present invention. FIGS. 8 and 9 illustrate actions taken by a consumer to redeem a virtual scratch card in accordance with the present invention. FIG. 8 illustrates redeeming a virtual scratch card utilizing an interactive voice response server 300 and FIG. 9 illustrates redeeming a virtual scratch card utilizing a text messaging system.

FIG. 8 illustrates the actions taken by the mobile communications device 150 (or optionally, a land line phone 155), an interactive voice response server 300, prepaid billing system server 500 and a virtual scratch card database 130 to redeem a virtual scratch card in accordance with the present invention. See also FIGS. 12 and 13 below. The virtual scratch card redemption process begins when the mobile communications device 150 receives an authentication prompt 801 from the interactive voice response server300, and responds with authentication information 805 to the interactive voice response server 300. This authentication information 805 may be any form of authentication information known to those of ordinary skill in the art, such as a consumer name and password or other forms of conventional authentication information. However, in one embodiment of the present invention the interactive voice response server 300 is operative to use voice recognition technology to authenticate a consumer based on their voice and previous voice authentication information. Once the interactive voice response server 300 receives the authentication information 805, the interactive voice server 300 then authenticates the consumer 810 and returns an authentication confirmation 815 to the mobile communications device 150. Next, the mobile communications device 150 communicates the virtual scratch card number 820 to the interactive voice response server 300. This may be accomplished in a myriad of fashions either through the consumer reading off a series of numbers representing the virtual scratch card, the consumer keying in the sequence of virtual scratch card numbers, or the consumer sending a message in audio format or other recognizable format to the interactive voice response server 300. The interactive voice response server 300 then formulates a message with the virtual scratch card number and consumer identification 825. This message 830 is then sent to the prepaid billing system server 500. The prepaid billing system server 500 then makes a virtual scratch card validity inquiry 835 to the virtual scratch card database 130. The virtual scratch card database checks to see that there is such a virtual scratch card that was validly issued and, if so, validates 840 the virtual scratch card. The validation is then returned 845 to the prepaid billing system server 500. The prepaid billing system server 500 then credits 850 the consumer's accounts with the value of the virtual scratch card and sends a signal to the virtual scratch card database 130 marking 855 the virtual scratch card as used in the redemption process. The prepaid billing system server 500 may also send a credit confirmation 860 back to the mobile communications device 150 passed via the interactive voice response server 300 to let the consumer know that the virtual scratch card has been redeemed and how much the consumer's account has been credited.

Similar to FIG. 8, FIG. 9 also illustrates a virtual scratch card redemption process, however, FIG. 9 illustrates the actions taken by the mobile communications device 150, mobile switching center 110, short message service center 120, a virtual scratch card proxy 210 and the prepaid billing system server 500 along with the virtual scratch card database 130 to redeem a virtual scratch card through a wireless messaging system. The wireless messaging virtual scratch card redemption process begins when the mobile communications device 150 forwards a virtual scratch card and consumer identification in a wireless message via the mobile switching center 110 and the short message service center 120 to the virtual scratch card proxy 210. The virtual scratch card proxy 210 then extracts 910 the virtual scratch card number from the message and the virtual scratch card number and consumer identification are sent 915 to the prepaid billing system server 500. The prepaid billing system server 500 sends a virtual scratch card validity query 920 to the virtual scratch card database 130 which then validates 925 the virtual scratch card. The virtual scratch card validation 930 is then returned to the prepaid billing system server 500. Once validated the prepaid billing system server 500 then credits the consumer's account with the value of the virtual scratch card 935 and marks the virtual scratch card as used 940 with the virtual scratch card database 130. The prepaid billing system server may also return a credit confirmation via the virtual scratch card proxy 210 short message service center 120 and mobile switching center 110 to the mobile communications device 150.

It will be appreciated by those of ordinary skill in the art that the order of operations in FIGS. 8 and 9 may be altered without substantially affecting the operation of the present invention. For example, the prepaid billing system server may send out a credit confirmation 860 or credit confirmation 945 before marking the virtual scratch card as used 855, 940 without departing from the spirit and scope of the present invention.

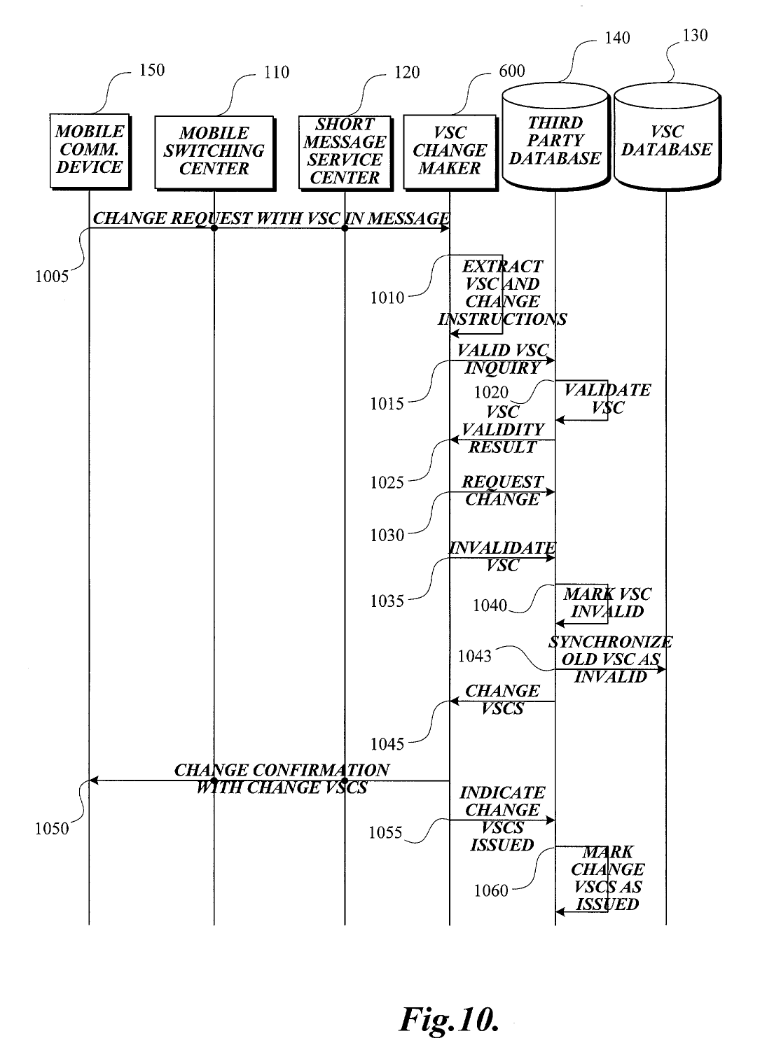

As in FIG. 9, FIG. 10 illustrates a process using wireless messaging from a mobile communications device 150. FIG. 10 illustrates the actions taken by the mobile communications device 150, mobile switching center 110, short message service center 120, a virtual scratch card change-maker 600, third party database 140, and the virtual scratch card database 130 to enable a consumer to make change from a virtual scratch card. The virtual scratch card change-making process begins when the mobile communications device forwards a virtual scratch card in a wireless message via the mobile switching center 110 and the short message service center 120 to the virtual scratch card change-maker 600. The virtual scratch card change-maker 600 then extracts 1010 the virtual scratch card and change instructions. For example, a virtual scratch card of a denomination of 20 might have change instructions of one 10, one 5 and five 1 denomination scratch cards as the desired change. The virtual scratch card change-maker then inquires 1015 of the third party database 140 whether the virtual scratch card is valid. The third party database 140 validates 1020 the virtual scratch card and returns 1025 with the virtual scratch card validation to the virtual scratch card change-maker 600. The virtual scratch card change-maker 600 next requests 1030 change virtual scratch cards from the third party database 140 for the correct amount in change. Next, the original virtual scratch card is invalidated 1035 by sending a message to the third party database 140. The third party database 140 marks 1040 the virtual scratch card as invalid and returns the change virtual scratch cards 1045 as a substitute for the now invalidated original virtual scratch card. Additionally, the third party database 140 synchronizes 1043 with the virtual scratch card database 130 so that the virtual scratch card database will know that the old or original virtual scratch card is now invalid. The status of being invalid does not mean that it has been issued and is therefore redeemable; it means that it is no longer issued and no longer usable hence the term “invalid.” Once the virtual scratch card change-maker receives the change virtual scratch cards, the virtual scratch card change-maker 600 confirms via a wireless message 1050 (that passes through the short message service center 120 and the mobile switching center 110 to reach the mobile communications device 150) that the change transaction has completed and the message includes the change virtual scratch cards for the consumer. Meanwhile, the virtual scratch card change-maker 600 informs 1055 the third party database that the change virtual scratch cards have been issued. The third party database 140 then marks the change virtual scratch cards as issued 1060.

It will be appreciated by those of ordinary skill in the art that the order of operations in FIG. 10 may be altered without substantially affecting the operation of the present invention. For example, the change virtual scratch cards may be returned to the virtual scratch card change-maker 600 prior to invalidating the original virtual scratch card without departing from the spirit and scope of the present invention.

The present invention is directed to providing consumers with compensation, coupons and other benefits via their mobile communications devices 150 in a manner similar to conventional physical scratch cards. However, instead of physical “scratch cards,” the consumer receives a virtual representation that provides similar benefits along with other benefits not found with physical scratch cards. For example, the consumer may transfer the virtual scratch card electronically, or even use it to pay bills online. Accordingly, FIG. 11 illustrates an exemplary logic routine 1100 on the third party server 400 for issuing virtual scratch cards to a consumer using their mobile communications device 150. Routine 1100 starts at block 1101 and proceeds to block 1105 where a virtual scratch card is retrieved from a third party database 140. Next, in block 1110, a message is formatted for issuing to the consumer enclosing the virtual scratch card. The message is then forwarded to a short message service center 120 in block 1115 for issuing to the consumer. It will be appreciated by those of ordinary skill in the art that a properly addressed message to a short message service center will be routed in a conventional manner to a designated recipient such as the consumer of the present invention via the mobile switching center 110 and the mobile communications device 150. In block 1120, the virtual scratch card is marked as issued in the third party database 140 to indicate that it has been issued to a consumer. Routine 1100 then ends in block 1199.

FIG. 12 illustrates the logic flow of a virtual scratch card redemption routine 1200 from the viewpoint of the interactive voice response server 300. Routine 1200 begins in block 1201 and proceeds to block 1203 where an authentication prompt is sent by the interactive voice response server 300 to the mobile communication device 150. Next, in block 1205 authentication information is received back from the mobile communication device 150. As discussed above with regard to FIG. 8, the authentication information may be any form of authentication known to those of ordinary skill in the art. Next, in block 1210 the authentication information is authenticated and if in decision block 1215 it is determined that the authentication was successful, then processing continues to block 1220, otherwise if it was unsuccessful, routine 1200 returns back to block 1203 to again prompt for authentication information.

Assuming that the authentication information as determined by decision block 1215 was authenticated, then processing continues to block 1220 and the interactive voice response server 300 sends an authentication confirmation to the mobile communication device 150. Now that the consumer has been authenticated in the next block 1225 when the virtual scratch card is received, the virtual scratch card can be associated with the authenticated consumer. Accordingly, in the next block 1230, a message is formulated with the consumer identification from the mobile communication device 150 and the virtual scratch card. Next in block 1235, the message with the consumer's identification and the virtual scratch card is forwarded to the prepaid billing system server 500 for further processing of the redemption (see FIG. 13). Processing of routine 1200 then ends at block 1299.

FIG. 13 illustrates the continuation of the redemption process on the prepaid billing system server 500. Routine 1300 begins at block 1301 and proceeds to block 1305 where the virtual scratch card and consumer identifier are received from the mobile communication device 150. Next, in block 1310, the virtual scratch card is validated at the virtual scratch card database 130. Next, a determination is made in decision block 1315 whether the virtual scratch card is both unused and valid. If a determination is made in decision block 1315 that the virtual scratch card is either redeemed or invalid, then processing continues to block 1335 where an error is transmitted to the consumer and routine 1300 ends at block 1399. If, however, in decision block 1315 it was determined that the virtual scratch card is both valid and unredeemed, then the logic flow continues to block 1320 where a credit is issued to the consumer's account as identified by the consumer identification with the value of the virtual scratch card. Then, in block 1325, the virtual scratch card is marked as used and stored in the VSC database 130 so that it may not be used again. In block 1330, the prepaid billing system server 500 transmits a confirmation of the credit back to the consumer. Then, at block 1399, routine 1300 ends.

FIG. 14 illustrates a change-making routine 1400 implemented by a virtual scratch card change-maker device 600 issuing “change” virtual scratch cards to a mobile communication device in response to the submission of a virtual scratch card along with a request for “change” in the form of virtual scratch cards. Routine 1400 begins at block 1401 and proceeds to block 1405 where a virtual scratch card change request including an original virtual scratch card is received from a mobile communications device 150. The contexts of the change request are then extracted in block 1407. Next, in block 1410, the original virtual scratch card is checked for validity with the third party database 140. Next a determination is made in decision block 1415 whether the original virtual scratch card is unredeemed and valid. If a determination is made in decision block 1415 that the original virtual scratch card is either redeemed or invalid, then processing continues to block 1445 where an error is transmitted to the consumer via the mobile communication device 150 and routine 1400 ends at block 1499. If, however, in decision block 1415 it was determined that the virtual scratch card is both valid and unredeemed, then the logic flow continues to block 1420 where the original virtual scratch card and instructions on the desired change scratch cards are transmitted to the third party database 140. Next, the original or old virtual scratch card is marked as invalid by the third party database 140 in block 1425. In block 1430, the multiple change virtual scratch cards are received from the third party database. Once the change virtual scratch cards have been successfully received, then the change virtual scratch cards are transmitted to the consumer in block 1435, along with a change confirmation. Finally, an indication is sent to the third party database to mark the virtual scratch cards as issued in block 1440 and processing ends in block 1499. It will be appreciated by those of ordinary skill in the art that the communications between the change-making device 600 and the consumer via their mobile communications device 150 may either take the form of wireless messages or may utilize an interactive voice response server such as interactive voice response server 300, similar to the voice and wireless message redemption steps in FIGS. 8 and 9.

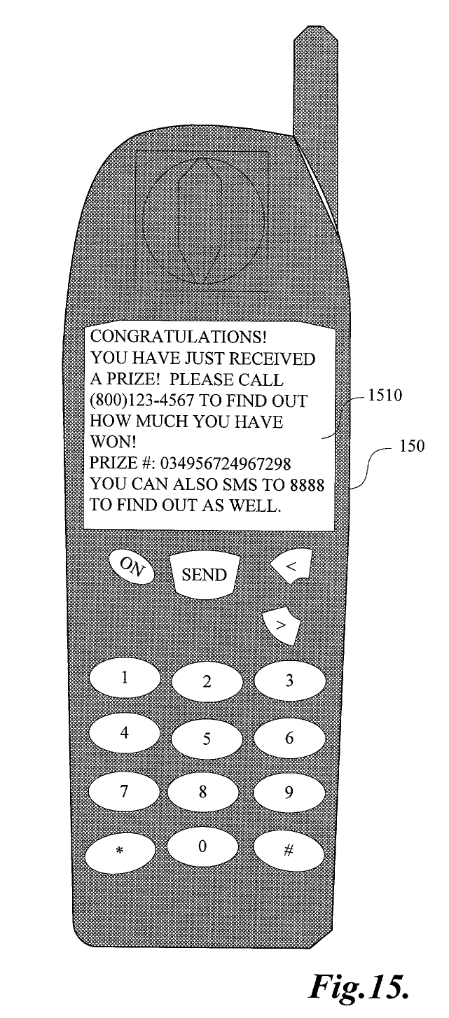

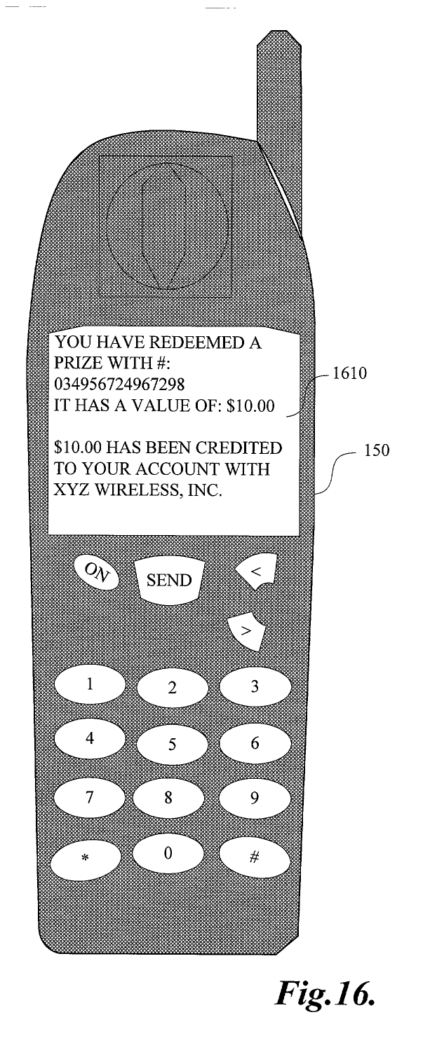

FIGS. 15 and 16 illustrate exemplary screen shots of mobile communications devices 150. In particular, FIG. 15 illustrates the receipt of a issuance of a virtual scratch card. Screen 1510 illustrates a message to the consumer indicating that they have received a prize (e.g., virtual scratch card) with a particular number and that they can dial a telephone number or send a wireless message to determine the value of the scratch card. FIG. 16 meanwhile illustrates the redemption of a virtual scratch card in accordance with the present invention. In particular, screen 1610 illustrates a message to the consumer confirming that a scratch card with a particular number had a value of $10 and that $10 has been credited to their account with their wireless service provider.

While the preferred embodiment of the invention has been illustrated and described, it will be appreciated that various changes can be made therein without departing from the spirit and scope of the invention. In particular, the virtual scratch cards themselves may constitute numbers, letters or any combination thereof which would allow a consumer to receive and redeem the virtual scratch card in accordance with the present invention. Still further, it is noted that the order of operations of various routines and communications between devices may at points be altered without substantially departing from the scope and spirit of the present invention.

The embodiments of the invention in which an exclusive property or privilege is claimed are defined as follows:

1. Method of issuing virtual scratch cards in a wireless network, the method comprising:
retrieving a virtual scratch card from a token database;
sending said message to a consumer device in the wireless network issuing said virtual scratch card to a consumer; and
marking said virtual scratch card as issued in said token database.

2. The method of claim 1, wherein said message is sent via a short message service.

3. The method of claim 1, wherein said message is sent via a wireless application protocol.

4. The method of claim 1, wherein said consumer device is a wireless phone.

5. The method of claim 1, wherein said consumer device is a computing device.

6. The method of claim 1, wherein said message is sent via e-mail.

7. The method of claim 1, further comprising said consumer device forwarding said message to a second consumer device.

8. Method of redeeming a virtual scratch card in a wireless network, the method comprising:
authenticating a redemption request from a consumer device;
validating a virtual scratch card included in said redemption request;
crediting an account associated with said consumer device upon validation of said virtual scratch card; and
marking said virtual scratch card as a used token in a token database.

9. The method of claim 8, wherein said redemption is sent via a short message service.

10. The method of claim 8, wherein said redemption request is sent via a wireless application protocol.

11. The method of claim 8, wherein said redemption message is sent via e-mail.

12. The method of claim 8, wherein said consumer device is a wireless telephone.

13. The method of claim 8, wherein said consumer device is a computing device.

14. The method of claim 8, wherein said consumer device is a landline telephone.

15. Method of claim 8, further comprising a second consumer device sending a message comprising said virtual scratch card to said consumer device.

16. A method of making change for a virtual scratch card in a wireless network environment, the method comprising:
authenticating a change request from a consumer device;
validating a first virtual scratch card included in said change request;
retrieving a plurality of virtual scratch cards equivalent to a value of said first virtual scratch card;
marking said first virtual scratch card as invalid; and
sending said plurality of virtual scratch cards to said consumer device.

17. The method of claim 16, wherein said change request is sent via a short message service.

18. The method of claim 16, wherein said change request is sent via a wireless application protocol.

19. The method of claim 16, wherein said change request is sent via e-mail.

20. The method of claim 16, wherein said consumer device is a cellular telephone.

21. The method of claim 16, wherein said consumer device is a computing device.

22. The method of claim 16, further comprising a second consumer device sending a message comprising said virtual scratch card to said consumer device.

23. A computing device implemented system for performing the methods of claims 1-7.

24. A computing device implemented system for performing the methods of claims 8-15.

25. A computing device implemented system for performing the methods of claims 16-22.

26. A computer readable medium containing computer executable instructions for performing the methods of claims 1-7.

27. A computer readable medium containing computer executable instructions for performing the methods of claims 8-15.

28. A computer readable medium containing computer executable instructions for performing the methods of claims 16-22.
